(19) United States
(12) Patent Application Publication
(10) Pub. No.: US 2009/0073458 A1
(43) Pub. Date: Mar. 19, 2009

(54) MEANS AND METHOD FOR DETERMINING THE SPATIAL POSITION OF MOVING ELEMENTS OF A COORDINATE MEASURING MACHINE

(75) Inventors: Michael Heiden, Wolfersheim (DE); Klaus Rinn, Heuchelheim (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/193,229

(22) Filed: Aug. 18, 2008

(30) Foreign Application Priority Data
Sep. 13, 2007 (DE) 10 2007 043 803.8

(51) Int. Cl. G01B 11/02; G01P 21/00

(52) U.S. Cl. 356/500; 702/95

(57) ABSTRACT

A means and a method for determining the spatial position of at least one moving element (9, 20) of a coordinate measuring machine (1) are disclosed. At least one laser interferometer (24) directs a measurement beam (23) to the moving element (9, 20). At least one laser interferometer directs a further measurement beam to the moving element to determine a rotation of the moving element (9, 20) around an X-coordinate direction or around a Y-coordinate direction or around a Z-coordinate direction.

### RELATED APPLICATIONS

This application claims priority to German Patent Application No. 10 2007 043 803.8, filed on Sep. 13, 2007, which is incorporated herein by reference in its entirety.

### FIELD OF THE INVENTION

The present invention relates to a means for determining the spatial position of at least one moving element of a coordinate measuring machine. In particular, at least one laser interferometer directs a measurement beam to the moving element.

The invention further relates to a method for determining the spatial position of at least one moving element of a coordinate measuring machine.

### BACKGROUND OF THE INVENTION

A coordinate measuring device is well-known from prior art. See, for example, the lecture script “Pattern Placement Metrology for Mask Making” by Dr. Carola Bläsing. The lecture was given on the occasion of the Semicon conference, Education Program, in Geneva on Mar. 31, 1998, wherein the coordinate measuring machine was described in detail. The structure of a coordinate measuring machine, as known, for example, from prior art, will be explained in more detail in the following description associated with FIG. 1.

German patent application DE 10 2005 052758 describes a substrate holding means to be used in a position measuring device for determining the position of a substrate carried by the substrate holding means. The determination of the position of the substrate holding means is effected by means of a laser interferometer system. The substrate holding means is provided in a movable table construction, wherein the table construction is provided with at least one fixedly associated table mirror for reflecting the at least one laser beam of the laser interferometer system. However, the system suggested therein does not allow determining tilts of the measurement objective and/or tilts or rotations of the measurement table.

### SUMMARY OF THE INVENTION

It is an object of the invention to provide a means allowing the determination of the measurement errors caused by the spatial rotation of the measurement table and/or the tilt of the measurement objective during the determination of the position of structures on a substrate, as well as allowing the correction of the measurement values corresponding to the tilt or rotation.

This object is achieved by a means for determining the spatial position of at least a first moving element and of at least a second moving element of a coordinate measuring machine, comprising: a measurement table of the coordinate measuring machine arranged to be movable in one plane in a X-coordinate direction and in a Y-coordinate direction, wherein the measurement table is the first moving element; a measurement objective arranged to be movable in a Z-coordinate direction, wherein the second moving element is the measurement objective; at least one reflecting surface formed on a surface of the measurement table; at least one reflecting surface provided on the measurement objective; and at least one laser interferometer for directing a measurement beam at the least one reflecting surface of the measurement table to determine a rotation of the measurement table around the X-coordinate direction or around the Y-coordinate direction or around the Z-coordinate direction and for directing a measurement beam at the least one reflecting surface of the measurement objective for determining a rotation of the measurement objective around an axis parallel to the X-coordinate direction and/or parallel to the Y-coordinate direction.

It is further an object of the invention to provide a method with which the rotation of the position of the measurement table and/or the tilt of the measurement objective may be determined, and that the measurement values of positions of structures on the substrate are corrected correspondingly based on the determined tilt and/or rotation.

This object is achieved by a method for determining the spatial position of at least one first moving element and at least one second moving element of a coordinate measuring machine, wherein a measurement table is the first moving element which is moved in a plane in a X-coordinate direction and in a Y-coordinate direction and a measurement objective is the second moving element wherein the measurement objective is arranged to be movable in the Z-coordinate direction, comprising the steps of:
directing a measurement beam of at least one laser interferometer onto at least one reflecting surface formed on a surface of the measurement table;
directing a measurement beam of the at least laser interferometer onto at least one reflecting surface of the measurement objective;
directing a further measurement beam to the at least one reflecting surface formed on a surface of the measurement table and/or directing a further measurement beam to the least one reflecting surface of the measurement objective; and
determining a rotation of the measurement table and or the measurement objective around an X-coordinate direction or around a Y-coordinate direction or around a Z-coordinate direction.

It is advantageous if, for determining the spatial position (the position in the X-coordinate direction, the Y-coordinate direction and the Z-coordinate direction) of at least one moving element of a coordinate measuring machine, at least one of the laser interferometers directs a further measurement beam to the moving element. In this way, the spatial position of this moving element may be determined. The further measurement beam allows determining a rotation of the moving element around an X-coordinate direction or around a Y-coordinate direction or around a Z-coordinate direction.

The moving element is a measurement table of the coordinate measuring machine arranged to be movable in one plane in the X-coordinate direction and in the Y-coordinate direction. The measurement table has at least one reflecting surface onto which the at least one laser interferometer directs the measurement beam and the further measurement beam. The measurement table is provided with a first reflecting surface perpendicular to the Y-coordinate direction and a second reflecting surface perpendicular to the X-coordinate direction.

In order to determine the rotation of the measurement table around an axis parallel to the X-coordinate direction, the measurement beam and the further measurement beam of the laser interferometer are directed to the reflecting surface parallel to the X-coordinate direction such that the measurement beam and the further measurement beam are separate from each other in the Z-coordinate direction. In order to determine the rotation of the measurement table around an axis parallel to the Y-coordinate direction, the measurement beam and the further measurement beam of a laser interferometer are directed to the reflecting surface parallel to the Y-coordinate direction such that the measurement beam and the further measurement beam are separate from each other in the Z-coordinate direction.

In order to determine the rotation of the measurement table around an axis parallel to the Z-coordinate direction, the measurement beam and the further measurement beam of a laser interferometer are directed to a reflecting surface parallel to the X-coordinate direction and/or to a reflecting surface parallel to the Y-coordinate direction such that the measurement beam and the further measurement beam are separate from each other in the X-coordinate direction and/or in the Y-coordinate direction.

The moving element may further be a measurement objective of the coordinate measuring machine. The measurement objective is arranged to be movable in the Z-coordinate direction and provided with at least one reflecting surface. The measurement beam emitted by the at least one laser interferometer and a further measurement beam are directed to the reflecting surface of the measurement objective. The measurement objective is provided with a reflecting surface parallel to the X-coordinate direction. The measurement objective may also be provided with a second reflecting surface parallel to the Y-coordinate direction. In order to determine the rotation of the measurement objective around an axis parallel to the X-coordinate direction, the measurement beam and the further measurement beam of a laser interferometer are directed to the reflecting surface parallel to the X-coordinate direction such that the measurement beam and the further measurement beam are separate from each other in the Z-coordinate direction. Similarly, in order to determine the rotation of the measurement objective around an axis parallel to the Y-coordinate direction, the measurement beam and the further measurement beam of the laser interferometer are directed to the reflecting surface parallel to the Y-coordinate direction such that the measurement beam and the further measurement beam are separate from each other in the Z-coordinate direction.

The means further has associated therewith a computer with a memory recording the calculation of the rotation of the measurement table in the X-coordinate direction and/or around the Y-coordinate direction and/or around the Z-coordinate direction and/or recording the calculation of the rotation of the measurement objective around the X-coordinate direction and/or around the Y-coordinate direction. The positions of structures on a substrate determined by the coordinate measuring machine are corrected with respect to the data regarding the rotation of the measurement table around the X-coordinate direction and/or around the Y-coordinate direction and/or around the Z-coordinate direction and/or with respect to the rotation of the measurement objective around the X-coordinate direction and/or around the Y-coordinate direction.

The means allows determining the spatial position of the measurement table relative to the spatial position of the measurement objective. At least one differential interferometer is provided for determining the position of the measurement table relative to the measurement objective. It is advantageous if a reference beam of the differential interferometer impinges on the at least one reflecting surface on the measurement objective, which may be arranged at the level of the main plane on the object side, although this must not necessarily be the case. The measurement light beam of the differential interferometer reaches the reflecting surface provided on the measurement table at the level of the object plane of the measurement objective.

The inventive method for determining the spatial position of at least one moving element of a coordinate measuring machine includes several steps. In a first step, a measurement beam is directed to the at least one moving element of the coordinate measuring machine by at least one laser interferometer. A further measurement beam is directed to the moving element by the at least one laser interferometer to determine a rotation of the moving element around an X-coordinate direction or around a Y-coordinate direction or around a Z-coordinate direction.

Further advantageous embodiments of the invention may be found in the dependent claims.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a schematic setup of a coordinate measuring machine according to prior art;

FIG. 2 also shows a schematic setup of a coordinate measuring machine according to prior art, wherein the potential tilt of a measurement table is indicated at the support of the measurement table;

FIG. 3 shows a schematic representation of a coordinate measuring machine, wherein a tilt of the measurement table is caused by uneven places in the support of the measurement table, the tilt being determinable with the help of the inventive interferometer arrangement;

FIG. 4 shows a schematic arrangement of a coordinate measuring machine, wherein a tilt of the measurement objective may be determined;

FIG. 5 shows a schematic setup of a coordinate measuring machine, wherein both the tilt of the measurement table and the tilt of the measurement objective may be determined with the interferometer;

FIG. 6 shows a top view of the prior art coordinate measuring machine illustrated in FIG. 2;

FIG. 7 also shows a top view of the coordinate measuring machine, wherein uneven places in the guiding straightedge cause a rotation of the table around the Z-coordinate axis when the measurement table is moved;

FIG. 8 shows a top view of the coordinate measuring machine allowing simultaneous measurement of the rotation of the measurement table around the Z-coordinate axis in the X-coordinate direction and in the Y-coordinate direction;

FIG. 9 shows a possible arrangement of the laser beams in a double-pass interferometer with respect to the table mirror;

FIG. 10 shows a distribution of the locations of incidence of the reference beams on the mirror attached to the measurement objective;

FIG. 11 shows the parameters used for the calculation of the tilt of the measurement table with respect to the X/Y plane;

FIG. 12 shows the definition of the parameters Δzₓ and Δz_{y}. Δz represents both parameters; and

FIG. 13 shows the parameters required for calculating the objective tilt.

### DETAILED DESCRIPTION OF THE PREFERRED EMBODIMENTS

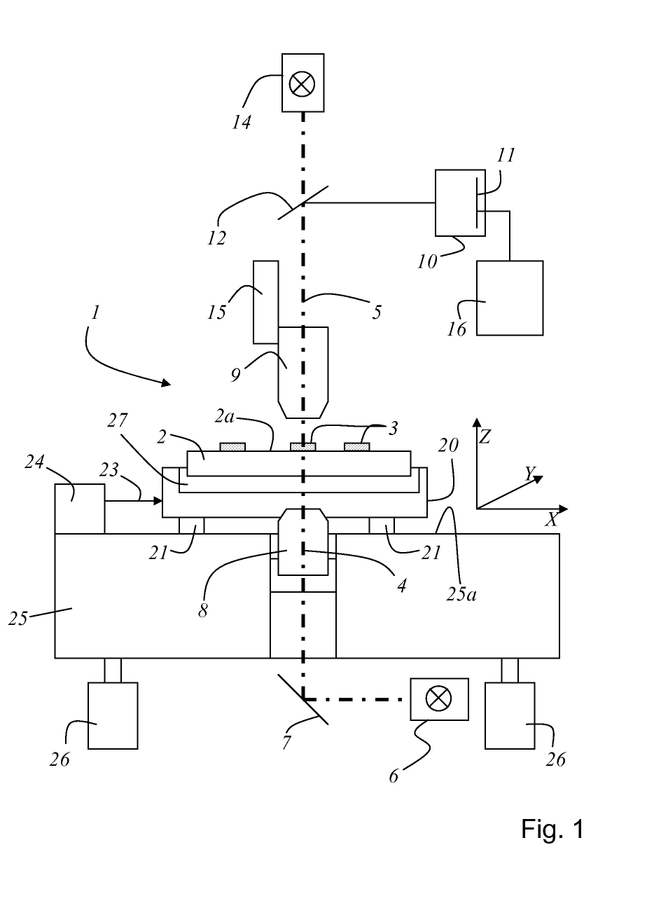

A coordinate measuring device 1 of the type shown in FIG. 1 is known from prior art and has been described in detail several times. The coordinate measuring device 1 includes a measurement table 20 movable in the X-coordinate direction and in the Y-coordinate direction. The measurement table 20 carries a substrate 2 or a mask for the semiconductor production. Several structures 3 are applied to the surface 2a of the substrate. The measurement table 20 itself is supported by air bearings 21 which, in turn, are supported by a block 25. Advantageously, the block 25 is formed of a granite block. The use of air bearings represents only one possible embodiment, and it is clear to anyone skilled in the art that other bearings may also be used to move the measurement table 20 in the X-coordinate direction and in the Y-coordinate direction on the plane 25a formed by the block 25. At least one incident light illumination means 14 and/or one transmitted light illumination means 6 are provided for the illumination of the substrate 2. In the embodiment shown, the light of the transmitted light illumination means 6 is launched into the illumination axis 4 for the transmitted light by means of a deflecting mirror 7. The light of the illumination means 6 reaches the substrate 2 via a condenser 8. The light of the incident light illumination means 14 reaches the substrate 2 through the measurement objective 9. The light coming from the substrate is collected by the measurement objective 9 and coupled out of the optical axis 5 by a semitransparent mirror 12. This measurement light reaches a camera 10 provided with a detector 11. A computing unit 16 with which digital images may be generated from the acquired data is associated with the detector 11.

The position of the measurement table 20 is measured and determined by means of at least one laser interferometer 24. For this purpose, the laser interferometer 24 emits a measurement light beam 23. Also, the measurement microscope 9 is connected to a displacing means in the Z-coordinate direction so that the measurement objective 9 may be focused on the surface of the substrate 2. The position of the measurement objective 9 may, for example, be measured with a glass scale (not shown). The block 25 is further positioned on legs 26 with an anti-vibration arrangement. This vibration damping is supposed to maximally reduce or eliminate all potential building vibrations and natural vibrations of the coordinate measuring device 1.

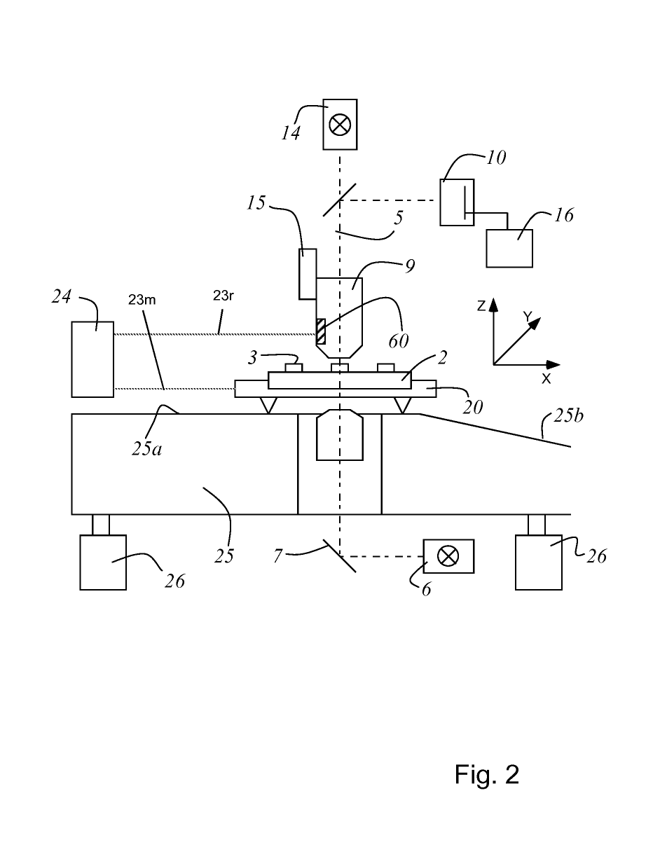

FIG. 2 shows a schematic setup of the coordinate measuring machine 1 often employed in prior art. The position of the measurement table 20 is determined by means of a differential interferometer 24. The position of the measurement table 20 is determined relative to the measurement objective 9. For this purpose, the measurement objective 9 comprises at least one reflecting surface 60 reached by a reference beam 23R coming from the interferometer 24. This reference beam 23R determines the distance to the measurement objective 9. Furthermore, the interferometer 24 emits a measurement beam 23M determining the distance of the measurement table 20 carrying the substrate 2 with the structures 23 provided thereon. A potential tilt of the measurement table 20 is indicated by the slope 25b of the measurement block 25. If the measurement table 20 moved in the area of the slope 25b, this would cause a tilt of the measurement table 20. As mentioned above, the current structure of the coordinate measuring machine 1 does not allow determining the tilt of the measurement objective 9 or a rotation of the measurement table 20. However, the tilt of the measurement objective 9 directly results in a lateral offset of the image. This offset is determined with the help of the image acquired by the camera 10 or the detector 11 of the camera. This offset obviously results in a measurement error, thus directly affecting the accuracy and/or the reproducibility of the coordinate measuring machine 1. Furthermore, the tilt of the measurement objective 9 is not completely reproducible. This means that the measurement objective 9 is tilted in a slightly different way for every focusing therewith. If a location on the substrate 2 is approached and measured several times, this will each time result in a different tilt of the measurement objective 9 and consequently also a different measurement value. This reduces the reproducibility of the coordinate measuring machine for the correspondingly measured position of the structure 3 on the substrate 2. Furthermore, the masks or substrates 2 may have slight imperfections with respect to their surfaces. This consequently results in different focus positions of the measurement objective 9 at different measurement locations. The mechanics 15 for the focus is therefore operated in different operating points at these locations. The tendency of the measurement objective 9 to tilt at these operating points will generally also be different. Thus the measurement locations each have a different systematic measurement error. This reduces the accuracy of the coordinate measuring machine 1. Also, only the position of the measurement table 2 is determined with the structure of the coordinate measuring machine 1 suggested in FIG. 1 and/or FIG. 2. It does not take into account whether the measurement table rotates (a rotation around the Z-coordinate direction) or tilts (a rotation around the X-coordinate direction or the Y-coordinate direction) when it is moved. As schematically illustrated in FIG. 2, this rotation in the X-coordinate direction or in the Y-coordinate direction may be illustrated by a schematic slope 25b of the block 25. This rotation of the measurement table 20 also results in measurement errors reducing the reproducibility and the accuracy of the measurement. A tilt of the measurement table 20 around the X-coordinate direction or the Y-coordinate direction may, for example, be caused by the uneven places in the surface 25a of the block 25. A rotation around the Z-coordinate direction may be caused by uneven places in one of the guiding straightedges of the measurement table.

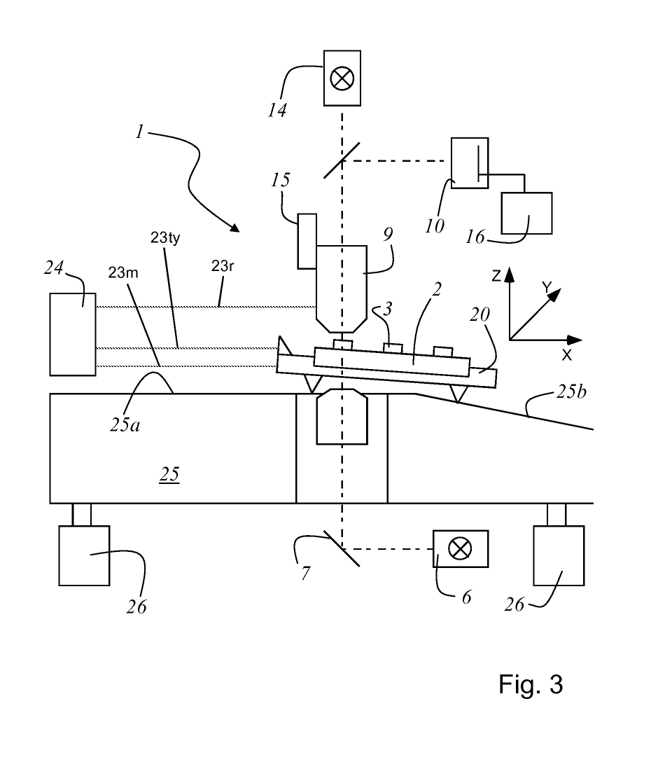

FIG. 3 shows a schematic representation of a coordinate measuring machine 1, wherein the measurement table 20 is moved in the direction of the X-coordinate direction. The block 25 comprises an uneven place 25b on the surface 25a. This uneven place is illustrated by a corresponding slope in FIG. 3. It is clear to someone skilled in the art that this illustration is greatly exaggerated and only provides a better understanding of the effect of the uneven places on the surface 25a of the block. The tilt of the measurement table 20 results in measurement errors when the positions of the structures 3 on the substrate 2 are determined. In order to determine the extent of the tilt and ultimately use the measurement result for correcting the measurement results with respect to the position determination of the structures 3 on the substrate 2, the interferometer 24 is provided with an additional measurement beam 23ty. A measurement beam 23m and a further measurement beam 23ty are directed from the interferometer 24 to a reflecting area of the measurement table 20. The tilt of the measurement table 20 around an axis parallel to the Y-coordinate direction may be determined from the difference in path length between the measurement beam 23M and the further measurement beam 23ty. The thus found tilt angle of the measurement table 20 may then be determined for correcting the position of the structures 3 on the substrate 2 determined with the help of the measurement objective 9. The tilt of the measurement table around an axis parallel to the X-coordinate direction may be determined with an identical setup in the Y-coordinate direction of the coordinate measuring machine 1.

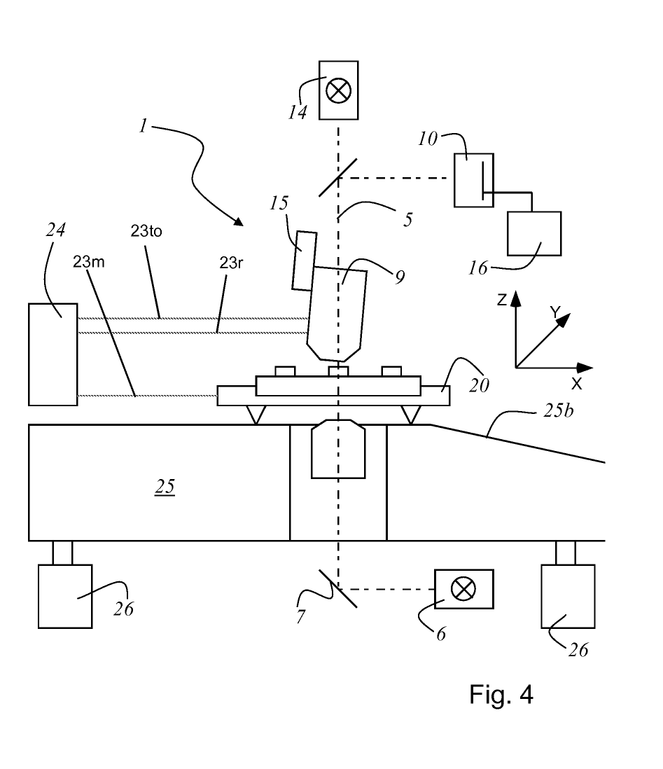

FIG. 4 shows a further embodiment of the invention, wherein the tilt of the measurement objective 9 may be determined with the help of an interferometer 24. In the illustration in FIG. 4, the adjustment of the measurement objective 9 in the Z-coordinate direction may cause a tilt of the measurement objective 9 around an axis parallel to the X-coordinate direction. The tilt angle of the measurement objective 9 may be determined with an additional measurement beam 23to and a reference beam 23r. The measurement result may be used for the positions of the structures 3 on the substrate 2 measured in the correction. Obviously, the tilt of the measurement objective 9 around an axis parallel to the X-coordinate direction may also be determined. For this measurement, a corresponding interferometer must be arranged in the Y-coordinate direction. The additional arrangement of a further interferometer for determining the tilt of the measurement objective in a further coordinate direction is obvious to someone skilled in the art and does not need to be described here.

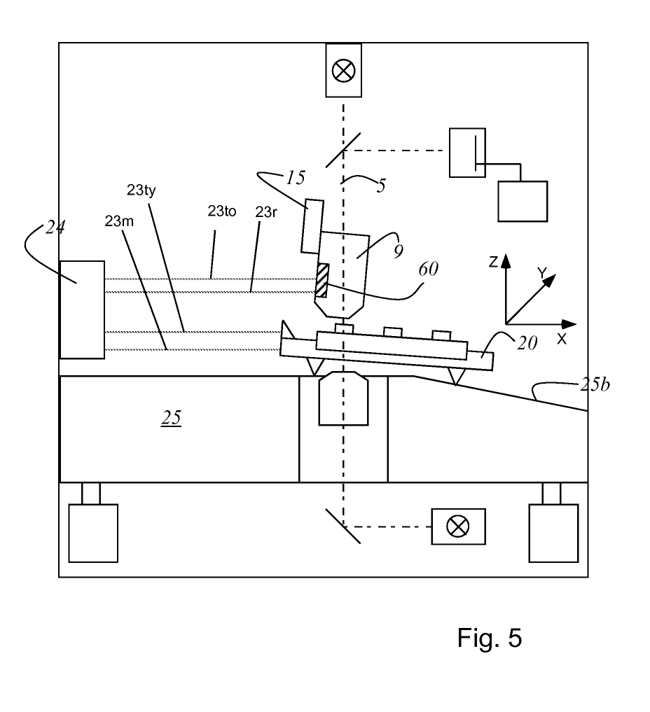

FIG. 5 shows an embodiment of the invention where both the tilt of the measurement objective and the tilt of the measurement table may be determined with a suitable interferometer. For this purpose, a measurement beam 23to and a further measurement beam 23r are directed from an interferometer 24 to a reflecting area 60 of the measurement objective 9. Similarly, a measurement beam 23ty and a further measurement beam 23m are directed for determining the tilt of the measurement table 20. At the same time, it is possible to determine the position of the measurement table 20 relative to the measurement objective from the further measurement beam 23r impinging on the measurement objective 9 and the measurement beam 23m impinging on a reflecting area on the measurement table 20. Furthermore, it is also possible to determine first a mean position of the measurement objective 9 from the measurement beams 23to and 23r, and a mean position of the measurement table 20 from the measurement beams 23ty and 23m. The relative position of the measurement table 20 with respect to the measurement objective 9 is obtained from a comparison of these previously determined mean positions. The same arrangement of an interferometer in the Y-coordinate direction is required for measuring the tilt around an axis parallel to the X-coordinate direction.

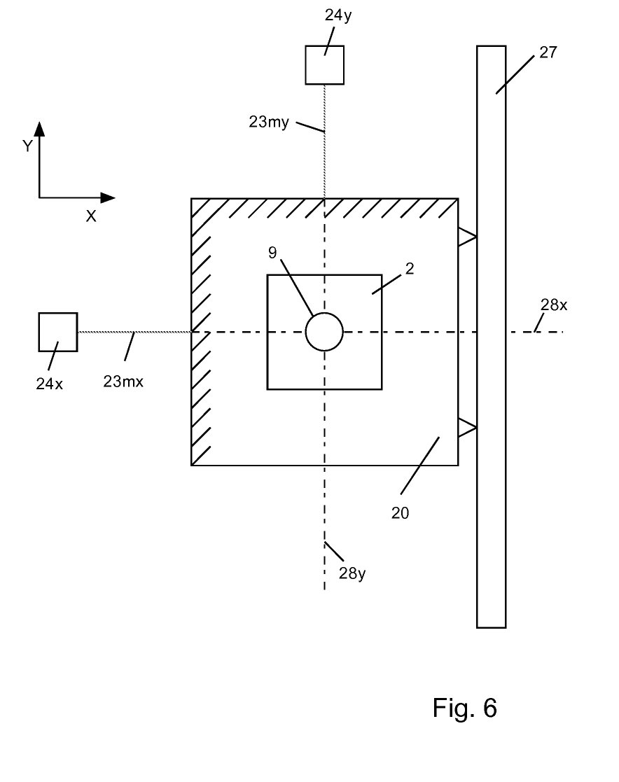

FIG. 6 shows a top view of the coordinate measuring machine 1, wherein only the measurement table 20, the substrate 2, the measurement objective 9 and a guiding straightedge 27 for the measurement table 20 are shown for reasons of clarity. The setup shown in FIG. 6 is a setup known from prior art. Interferometers 24x and 24y are provided for measuring the position of the measurement table in the X-coordinate direction and in the Y-coordinate direction, respectively. The guiding straightedge 27 oriented in the Y-coordinate direction causes the measurement table 20 to move in a straight line during the translation along the Y-coordinate direction. Correspondingly, there is also a guiding straightedge (not shown) for the translation of the measurement table 20 along the X-coordinate direction.

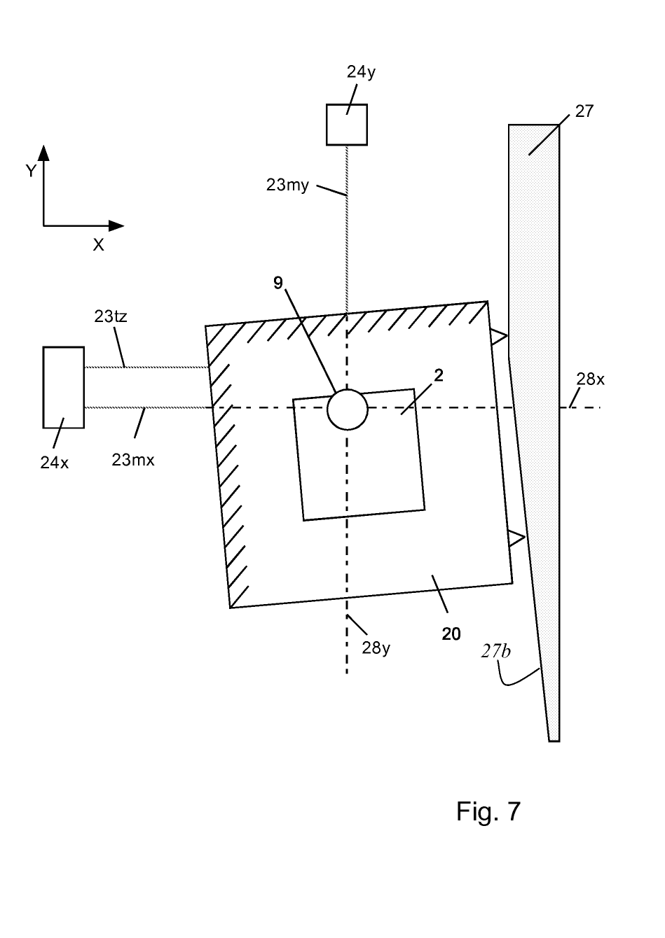

FIG. 7 also shows a top view of the coordinate measuring machine 1, wherein the guiding straightedge 27 comprises an uneven place 27b. The uneven place 27b is illustrated in an exaggerated manner, which, however, serves to show the rotation of the measurement table 20 more clearly. The uneven place 27b in the guiding straightedge 27 oriented along the Y-coordinate direction causes a rotation around the Z-coordinate direction when the measurement table 20 is moved. In the illustration shown in FIG. 7, the Z-coordinate direction projects out of the drawing plane. The rotation of the measurement table 20 around the Z-coordinate direction is determined with the help of an additional measurement beam 23tz emitted by the interferometer 24x oriented in the X-coordinate direction, together with a further measurement beam 23mx. It is clear to someone skilled in the art that a corresponding arrangement of an interferometer 24y may also be oriented in the Y-coordinate direction to determine a rotation of the measurement table therewith. An uneven place in the guiding straightedge (not shown) along the X-coordinate direction also causes a rotation of the measurement table 20, which can be measured with this arrangement. The measurement table 20 rotates as a unit. If a further interferometer is oriented in the direction of the Y-coordinate direction and the rotation of the table around the Z-coordinate direction is also determined with two measurement beams, this yields the same result for the two measurements, and redundant information is obtained with which the measurements acquired with the interferometers 24x and 24y may be checked for consistency. A suddenly occurring, different angle measurement would indicate that there is a malfunction of the interferometer (a malfunction may, for example, be caused by atmospheric influences). If such a result were detected, the measurement would have to be discarded and repeated.

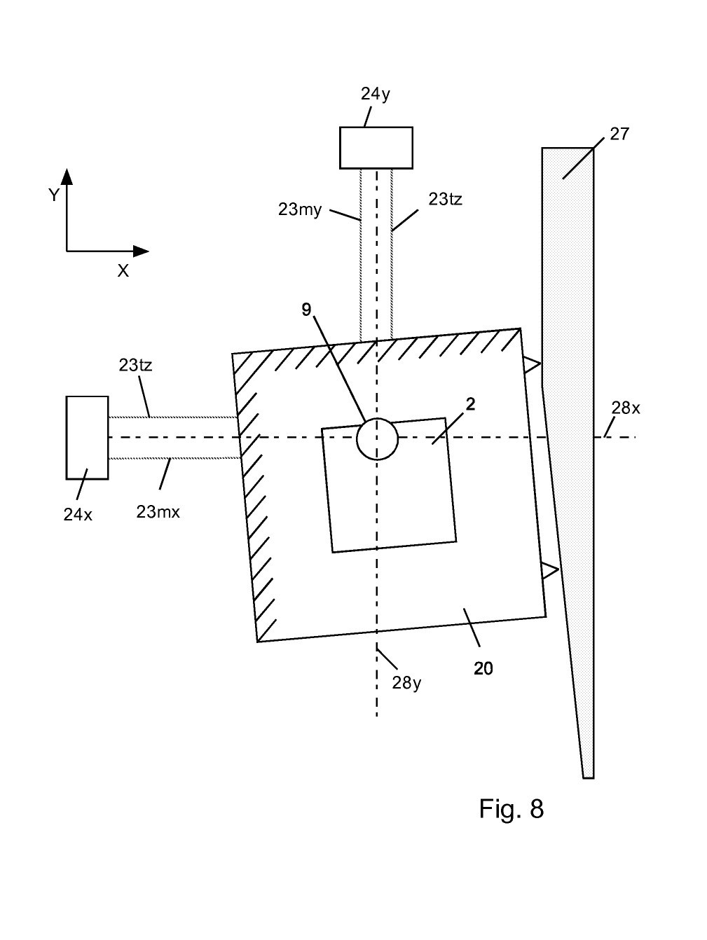

FIG. 8 shows a further embodiment, wherein the rotation of the measurement table 20 around the Z-coordinate direction is simultaneously measured in the X-coordinate direction and in the Y-coordinate direction. In order to keep the Abbe error at a minimum, the measurement beams of the interferometers 24x and 24y should intersect the optical axis 5 of the measurement objective 9. The measurement should thus be conducted along the axes 28x and 28y, which intersect each other in the optical axis 9 of the measurement objective. In order to reduce the noise of the laser axes, the mean position of the measurement table 20 may be determined from the measurements along the measurement beams 23tz and 23MZ. In order to avoid the Abbe error mentioned above, the measurement beams should be arranged to be symmetrical with respect to the axes 28x and 28y in any case. The position of the measurement table 20 may be determined from the mean value of the measurements with the measurement beams 23mx and 23tz.

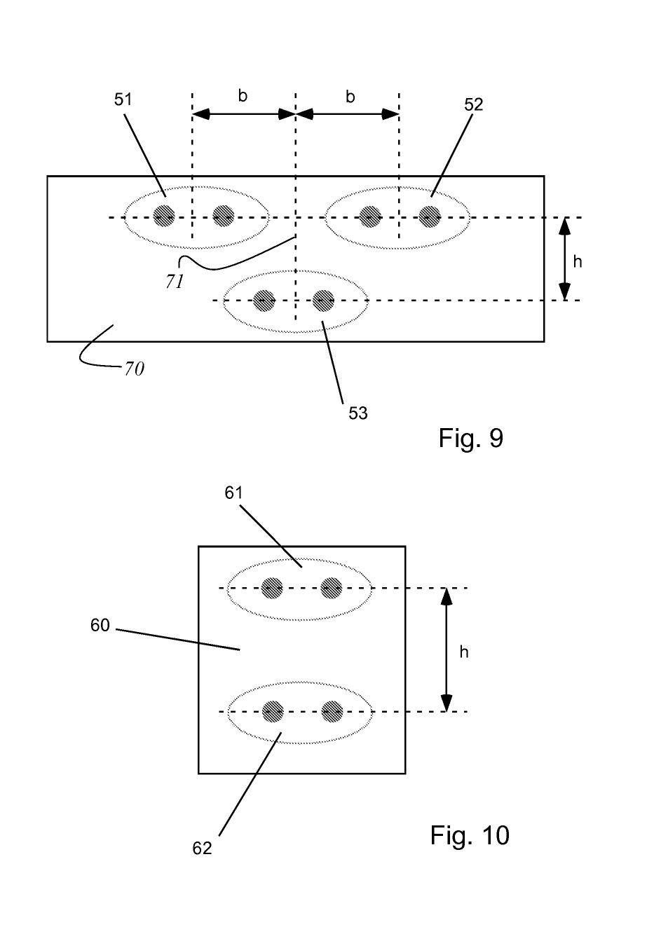

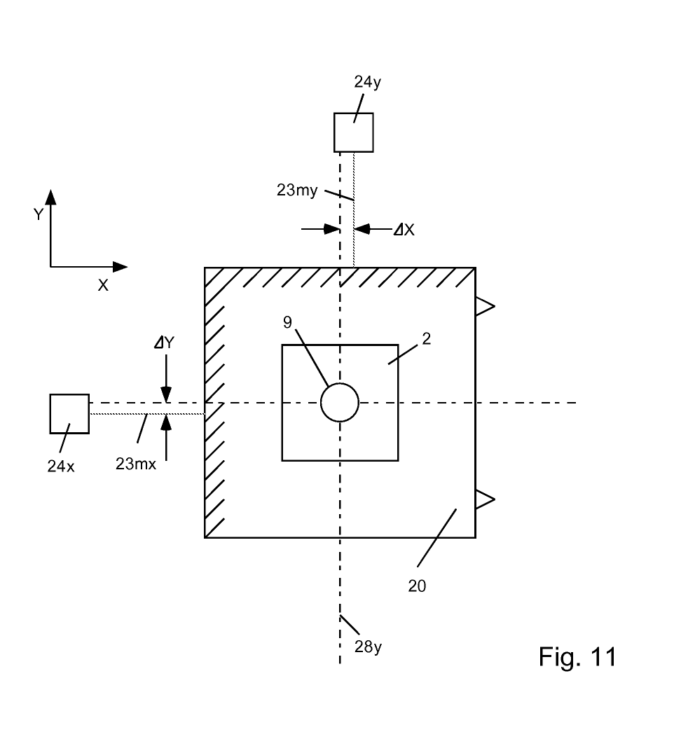

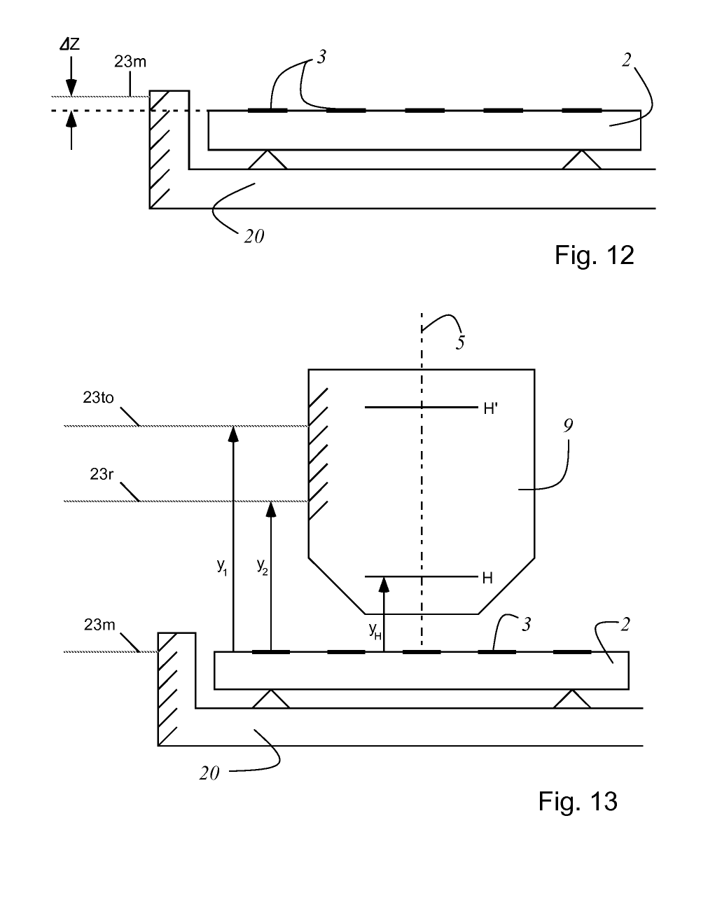

FIG. 9 shows a possible arrangement of the measurement beams 51, 52, 53 in a double-pass interferometer. The illustration shown in FIG. 9 shows the distribution of the measurement beams 51, 52, 53 on the reflecting portion 70 of the measurement table 20. It is clear to someone skilled in the art that another arrangement of the measurement beams 51, 52, 53 is also possible. What is important is that the measurement beams 51, 52, 53 are not all in one line. The measurement beams 51 and 52 are each at a distance b from a center line 71 in the X-coordinate direction and in the Y-coordinate direction, respectively. The measurement beams 51 and 52 are at a distance h from the measurement beam 53 in the Z-coordinate direction. The same arrangements may also be used for single-pass or multi-pass interferometers. This arrangement allows determining all tilts of the measurement table 20 around this position. If, for example, the position measurement of the measurement table 20 by the beam pair 51 is referred to as X₅₁, the position of the measurement table may be calculated from:

$${x}_{stage} = \frac{{x}_{51} + {x}_{52} + {x}_{53}}{3}$$

The tilt of the measurement table 20 around the Y-coordinate direction is given by:

$$tan ( {α}_{Y} ) = \frac{{x}_{51} + {x}_{52} - 2 {x}_{53}}{2 h}$$

And the tilt around the Z-coordinate direction is given by:

$$tan ( {α}_{Z} ) = \frac{{x}_{51} - {x}_{52}}{2 b}$$

FIG. 10 shows the arrangement of the reference beams 61, 62 as they impinge on the reflecting surface 60 of the measurement objective 9. The measurement beams 61 and 62 are separated from each other in the Z-coordinate direction by a value h. The position of the reflecting surface on the measurement objective 9 is obtained from:

$${x}_{reference} = \frac{{x}_{61} + {x}_{62}}{2}$$

And the tilt of the measurement objective 9 around the Y-coordinate axis is given by:

$$tan ( {β}_{Y} ) = \frac{{x}_{61} - {x}_{62}}{h}$$

The description of the invention given above allows determining and measuring rotations and tilts of individual elements of a coordinate measuring machine. The moving elements of the coordinate measuring machine 1 are essentially the measurement table 20 and the measurement objective 9. In order to determine the rotation or the tilt of the measurement objective 9 and the measurement table 20, additional measurement axes or measurement beams determining the rotation around the X-coordinate direction and/or the Y-coordinate direction and/or the Z-coordinate direction are added to a differential interferometer measuring the relative position of the measurement table 20 with respect to the measurement objective 9. This additional angle information permits correcting the measured values of the differential interferometer. A typical error in this context is the Abbe error. Although it may be avoided in the coordinate measuring machine 1 by arranging the measurement beam of the differential interferometer at the level of the structures on the substrate, mechanical tolerances always cause the measurement beam to be located outside this plane. This error may be mathematically corrected by the additional angle measurement and the determination of the deviation of the measurement beam from the plane of the structures 3 on the substrate 2. The position error caused by tilting the objective may be corrected in a similar way. For this purpose, the rotation of the measurement objective 9 around the X-coordinate direction and the Y-coordinate direction must be determined. If the imaging properties of the objective are known (by measuring or known from the optics calculation), a formula for correcting the error may be established.

The correction for the tilt of the measurement table 20 is given by:

x_{corr}=Δy sin(α_{Z})+Δz sin(α_{Y})≅Δyα_{Z}+Δzα_{Y}

y_{corr}=Δx sin(α_{Z})+Δzₓ sin(α_{X})≅Δxα_{Z}+Δzα_{X}

Δx represents the x-offset of the laser beam 23my in the interferometer of the Y-direction, Δzₓ represents the distance between the laser beam 23m and the mask surface, Δy represents the y-offset of the laser beam 23mx of the interferometer of the X-direction, and Δz_{y} represents the distance between the laser beam (23m) and the mask surface. The angles αₓ, α_{y} and α_{z} are obtained from the measurements of the interferometers.

The parameters Δx, Δy, Δzₓ and Δz_{y} are all zero as far as the construction of the machine is concerned. However, due to production tolerances, a value other than zero is obtained in the real machine for all these parameters. For example, an error in mask thickness directly results in a change of the parameters Δzₓ and Δz_{y}. If the deviation of the mask thickness from its nominal value is known, it may immediately be used for the correction of the measured values in the above equation.

The parameters will therefore generally be determined in a measurement. For this purpose, a function

x_{corr}=d₁ sin(α_{Z})+d₂ sin(α_{Y})

y_{corr}=d₃ sin(α_{Z})+d₄ sin(α_{X})

or

x_{corr}=d₁α_{Z}+d₂α_{Y}

y_{corr}=d₃α_{Z}+d₄zα_{X}

may, for example, be fitted to the measurement data. The general case of a fit function is given by:

$$( \begin{matrix}{x}_{corr} \\ {y}_{corr}\end{matrix} ) = ( \begin{matrix}{d}_{11} & {d}_{12} & {d}_{13} \\ {d}_{21} & {d}_{22} & {d}_{23}\end{matrix} ) ( \begin{matrix}{α}_{X} \\ {α}_{Y} \\ {α}_{Z}\end{matrix} )$$

$$or \\ ( \begin{matrix}{x}_{corr} \\ {y}_{corr}\end{matrix} ) = ( \begin{matrix}{d}_{11} & {d}_{12} & {d}_{13} \\ {d}_{21} & {d}_{22} & {d}_{23}\end{matrix} ) ( \begin{matrix}f ( {α}_{X} ) \\ g ( {α}_{Y} ) \\ h ( {α}_{Z} )\end{matrix} )$$

The functions f, g, h represent a trigonometric function (sin, cos, tan, . . . ). The parameters dᵢⱼ are adapted to the data of a calibration measurement. It is possible that, during a measurement, the parameters dᵢⱼ are again adapted to the actual measurement situation. For example, the deviation of the mask thickness from its nominal value may additionally be taken into account in these parameters.

Given the position of the reference mirror and the tilt of the mirror around the Y-axis, the correction regarding the current position measurement is calculated by:

$${x}_{corr} = ( \frac{{y}_{1} + {y}_{2}}{2} - {y}_{H} ) tan ( {β}_{Y} ) - {x}_{reference}$$

y₁ represents the distance between the laser beam 23to and the mask, y₂ represents the distance between the laser beam 23r and the mask, and y_{H} represents the distance between the main plane H on the object side and the mask. These values are known from the construction of the machine or the objective, or they may be measured. The laser beam 23m impinges on the mirror on the measurement table 20 at the level of the mask surface.
In the case of a very small tilt angle β_{Y}, this formula may also be simplified:

$${x}_{corr} = ( \frac{{y}_{1} + {y}_{2}}{2} - {y}_{H} ) {β}_{Y} - {x}_{reference}$$

using the relation tan(β_{Y})≈β_{Y} for small angles β_{Y}. Correspondingly, the correction for the Y-measurement values may be obtained as follows:

$${y}_{corr} = ( \frac{{y}_{1} + {y}_{2}}{2} - {y}_{H} ) tan ( {β}_{X} ) - {y}_{reference}$$

$$or$$

$${y}_{corr} = ( \frac{{y}_{1} + {y}_{2}}{2} - {y}_{H} ) {β}_{X} - {y}_{reference}$$

The parameters of the equation may also be determined from measured values. For this purpose, a function of the above type is fitted to the measurement data of a calibration measurement.

Correction values for the positions of structures on a substrate determined by the coordinate measuring machine 1 may be determined with respect to the data regarding the rotation of the measurement table around the X-coordinate direction and/or around the Y-coordinate direction and/or around the Z-coordinate direction and/or with respect to the data of the rotation of the measurement objective around the X-coordinate direction and/or around the Y-coordinate direction. These correction values are determined from a linear equation of the following type:

x_{corr}=c₁β+c₂x_{reference} or

x_{corr}=c₁ tan(β)+c₂x_{reference} or

x_{corr}=c₁f(β)+c₂x_{reference}

The constants c₁ and c₂ may be calculated from machine parameters or may be fitted to measurement data. The function f is a trigonometric function (sin, cos, tan, . . . ). Polynomials of a higher degree may also be used in β or x_{reference}.

While this invention has been particularly shown and described with references to preferred embodiments thereof, it will be understood by those skilled in the art that various changes in form and details may be made therein without departing from the scope of the invention encompassed by the appended claims.

What is claimed is:

1. A means for determining the spatial position of at least a first moving element and of at least a second moving element of a coordinate measuring machine, comprising:
a measurement table of the coordinate measuring machine arranged to be movable in one plane in a X-coordinate direction and in a Y-coordinate direction, wherein the measurement table is the first moving element;
a measurement objective arranged to be movable in a Z-coordinate direction, wherein the second moving element is the measurement objective;
at least one reflecting surface formed on a surface of the measurement table;
at least one reflecting surface provided on the measurement objective; and
at least one laser interferometer for directing a measurement beam at the least one reflecting surface of the measurement table to determine a rotation of the measurement table around the X-coordinate direction or around the Y-coordinate direction or around the Z-coordinate direction and for directing a measurement beam at the least one reflecting surface of the measurement objective for determining a rotation of the measurement objective around an axis parallel to the X-coordinate direction and/or parallel to the Y-coordinate direction.

2. The means of claim 1, wherein the measurement table is provided with a first reflecting surface perpendicular to the Y-coordinate direction, and that the measurement table is provided with a second reflecting surface perpendicular to the X-coordinate direction.

3. The means of claim 2, wherein for determining the rotation of the measurement table around an axis parallel to the Y-coordinate direction, the measurement beam and a further measurement beam of the at least one laser interferometer are directed to the reflecting surface parallel to the Y-coordinate direction such that the measurement beam and the further measurement beam are separate from each other in the Z-coordinate direction and wherein for determining the rotation of the measurement table around an axis parallel to the Z-coordinate direction, the measurement beam and the further measurement beam of a laser interferometer are directed to the reflecting surface parallel to the X-coordinate direction and/or to the reflecting surface parallel to the Y-coordinate direction such that the measurement beam and the further measurement beam are separate from each other in the X-coordinate direction and/or in the Y-coordinate direction.

4. The means of claim 1, wherein the measurement objective is provided with a first reflecting surface parallel to the X-coordinate direction with a second reflecting surface parallel to the Y-coordinate direction.

5. The means of claim 4, wherein for determining the rotation of the measurement objective around an axis parallel to the X-coordinate direction, the measurement beam and the further measurement beam of the at least one laser interferometer are directed to the reflecting surface parallel to the X-coordinate direction such that the measurement beam and the further measurement beam are separate from each other in the Z-coordinate direction and wherein for determining the rotation of the measurement objective around an axis parallel to the Y-coordinate direction, the measurement beam and the further measurement beam of a laser interferometer are directed to the reflecting surface parallel to the Y-coordinate direction such that the measurement beam and the further measurement beam are separate from each other in the Z-coordinate direction.

6. The means of claim 1, wherein a computer with a memory is provided for recording the calculation of the rotation of the measurement table around the X-coordinate direction and/or around the Y-coordinate direction and/or around the Z-coordinate direction and/or recording the calculation of the rotation of the measurement objective around the X-coordinate direction and/or around the Y-coordinate direction so that the positions of structures on a substrate determined by the coordinate measuring machine may be corrected with respect to the data regarding the rotation of the measurement table around the X-coordinate direction and/or around the Y-coordinate direction and/or around the Z-coordinate direction and/or with respect to the data of the rotation of the measurement objective around the X-coordinate direction and/or around the Y-coordinate direction.

7. The means of claim 1, wherein the spatial position of the measurement table is determinable relative to the spatial position of the measurement objective.

8. The means of claim 1, wherein at least one differential interferometer is provided for determining the position of the measurement table relative to the measurement objective.

9. The means of claim 8, wherein a reference beam of the at least one differential interferometer impinges on the at least one reflecting surface on the measurement objective at the level of the main plane on the object side, and that the measurement light beam of the differential interferometer impinges on the reflecting surface provided on the measurement table at the level of the object plane of the measurement objective.

10. A method for determining the spatial position of at least one first moving element and at least one second moving element of a coordinate measuring machine, wherein a measurement table is the first moving element which is moved in a plane in a X-coordinate direction and in a Y-coordinate direction and a measurement objective is the second moving element wherein the measurement objective is arranged to be movable in the Z-coordinate direction, comprising the steps of:
directing a measurement beam of at least one laser interferometer onto at least one reflecting surface formed on a surface of the measurement table;
directing a measurement beam of the at least laser interferometer onto at least one reflecting surface of the measurement objective;
directing a further measurement beam to the at least one reflecting surface formed on a surface of the measurement table and/or directing a further measurement beam to the least one reflecting surface of the measurement objective; and
determining a rotation of the measurement table and or the measurement objective around an X-coordinate direction or around a Y-coordinate direction or around a Z-coordinate direction.

11. The method of claim 10, wherein the measurement table is provided with a first reflecting surface perpendicular to the Y-coordinate direction, and that the measurement table is provided with a second reflecting surface perpendicular to the X-coordinate direction.

12. The method of claim 10, wherein the rotation of the measurement table around an axis parallel to the X-coordinate direction is determined such that the measurement beam and the further measurement beam of the at least one laser interferometer are directed to the reflecting surface parallel to the X-coordinate direction such that the measurement beam and the further measurement beam are separate from each other in the Z-coordinate direction an wherein the rotation of the measurement table around an axis parallel to the Y-coordinate direction is determined such that the measurement beam and the further measurement beam of a laser interferometer are directed to the reflecting surface parallel to the Y-coordinate direction such that the measurement beam and the further measurement beam are separate from each other in the Z-coordinate direction.

13. The method of claim 12, wherein the rotation of the measurement table around an axis parallel to the Z-coordinate direction is determined such that the measurement beam and the further measurement beam of a laser interferometer are directed to the reflecting surface parallel to the X-coordinate direction and/or to the reflecting surface parallel to the Y-coordinate direction such that the measurement beam and the further measurement beam are separate from each other in the X-coordinate direction and/or in the Y-coordinate direction.

14. The method of claim 10, wherein the measurement objective is provided with a first reflecting surface parallel to the X-coordinate direction, and that the measurement objective is provided with a second reflecting surface parallel to the Y-coordinate direction.

15. The method of claim 14, wherein the rotation of the measurement objective around an axis parallel to the X-coordinate direction is determined such that the measurement beam and the further measurement beam of a laser interferometer are directed to the reflecting surface parallel to the X-coordinate direction such that the measurement beam and the further measurement beam are separate from each other in the Z-coordinate direction an wherein the rotation of the measurement objective around an axis parallel to the Y-coordinate direction is determined such that the measurement beam and the further measurement beam of a laser interferometer are directed to the reflecting surface parallel to the Y-coordinate direction such that the measurement beam and the further measurement beam are separate from each other in the Z-coordinate direction..

16. The method of claim 10, wherein there is provided a computer with a memory recording the calculation of the rotation of the measurement table around the X-coordinate direction and/or around the Y-coordinate direction and/or around the Z-coordinate direction and/or recording the calculation of the rotation of the measurement objective around the X-coordinate direction and/or around the Y-coordinate direction so that the positions of structures on a substrate determined by the coordinate measuring machine are corrected with respect to the data regarding the rotation of the measurement table around the X-coordinate direction and/or around the Y-coordinate direction and/or around the Z-coordinate direction and/or with respect to the data of the rotation of the measurement objective around the X-coordinate direction and/or around the Y-coordinate direction.

17. The method of claim 10, wherein it allows determining the correction values for measurements of positions of structures on a substrate determined by the coordinate measuring machine with respect to the data regarding the rotation of the measurement table around the X-coordinate direction and/or around the Y-coordinate direction and/or around the Z-coordinate direction and/or with respect to the data of the rotation of the measurement objective around the X-coordinate direction and/or around the Y-coordinate direction from a linear equation of the following type:
x_{corr}=c₁β+c₂x_{reference} or
x_{corr}=c₁ tan(β)+c₂x_{reference} or
x_{corr}=c₁f(β)+c₂x_{reference}
